(19) United States
(12) Patent Application Publication
(10) Pub. No.: US 2006/0098945 A1
(43) Pub. Date: May 11, 2006

(54) Method for storing audio data of audio and video (AV) device

(75) Inventor: Eung-sun Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/982,894

(22) Filed: Nov. 8, 2004

(51) Int. Cl. H04N 5/781

(52) U.S. Cl. 386/98; 386/125

(57) ABSTRACT

A method for storing audio data of an audio and video (AV) device, the method including displaying on a menu screen file names and additional information corresponding to audio data read from an optical media player, selecting at least one of the file names displayed on the menu screen, and setting a compression format to compress the audio data corresponding to the selected at least one file name, compressing the audio data according to the set compression format, and storing the compressed data in a storage medium. The audio data of the CD-DA format is converted according to an MPEG format and the sampling rate, and the converted audio data is stored in the AV device having the storage medium such as the HDD or the flash ROM, therefore, increasing storage time of the storage medium of the AV device.

### BACKGROUND OF THE INVENTION

1. Field of the Invention

The present invention in general relates to a method for storing audio data of an audio and video (AV) device. More specifically, the present invention relates to a method for compressing and storing audio data according to a compression format such as an MPEG (Moving Picture Experts Group) when the audio data of a CD-DA (compact disk digital audio) format is applied to an AV device having an optical media player.

2. Description of the Related Art

An AV (audio and video) device such as a record player and a video tape recorder, generally is provided with an optical media drive, for example, a CD (compact disk) player and a DVD (digital versatile disk) player, for reproducing audio signals of a CD-DA (compact disk digital audio) format. The CD-DA format is used to store on and reproduce from the CD, audio data which is converted from an analog signal having about 20 kHz band to a digital signal at a sampling rate of 44.1 kHz according to Nyquist sampling theorem without compressing.

CD-DA specifications provide two channels (left and right) and each channel consists of 16 bits. Hence, data generated per minute becomes about 10.5 Mbytes (=44,100 bits×16 bits×2 channels×60 seconds). General audio data having a reproduction time of about 4˜5 minutes is about 40˜50 Mbytes in size, and a music CD having a storage capacity of about 600 Mbytes can contain 10 pieces of data or so. After compressing the audio data in about 4˜5 minute lengths in an MPEG-2 format, the data capacity of the compressed data is typically several Mbytes while that of the digital audio data of the CD-DA format is tens of Mbytes.

Recently, an optical media player, which is capable of reproducing music from the CD of the CD-DA format, is frequently combined with a conventional AV device such as a record player, a video tape recorder, and a DVD player. Particularly, the optical media player is prevalently combined with the AV device having a hard disk drive or a flash ROM (for example, a DVD player and a MP3 player). However, when storing audio data in the hard disk drive or the flash ROM, storage of the audio data is restrained because the size of the audio data of the CD-DA format is large.

### SUMMARY OF THE INVENTION

To address the above and/or disadvantages of the conventional arrangement, an exemplary aspect of the present invention provides a method for compressing and storing audio data of CD-DA format in an AV device capable of reproducing the audio data of the CD-DA format.

According to an aspect of the present invention, there is provided a method for storing audio data in an audio and video (AV) device having a display displaying a menu screen, an optical media player reading the audio data, and a storage medium storing the read audio data. The method includes displaying on the menu screen file names and additional information corresponding to the audio data read from the optical media player, selecting at least one of the file names displayed, and setting a compression format to compress audio data corresponding to the selected file name, compressing the audio data according to the set compression format, and storing the compressed data in the storage medium.

According to another aspect of the present invention, the method further includes changing and storing a sampling rate of the audio data corresponding to the selected file name in the storage medium.

According to another aspect of the present invention, the menu screen includes a menu indicating the file names of the audio data, a check box menu disposed on a side of the menu indicating the file names in correspondence with the file names, and a menu for copying in the storage medium the audio data corresponding to the file name selected through the check box menu.

According to another aspect of the present invention, the menu screen includes a menu for selecting or clearing all of the file names selected through the check box menu.

According to another aspect of the present invention, the menu screen includes a format set menu setting the compression format of a file corresponding to the file name selected through the check box menu.

According to another aspect of the present invention, the menu screen includes a sampling rate set menu setting the sampling rate of the file corresponding to the file name selected through the check box menu.

According to another aspect of the present invention, the sampling rate set menu is popped up on a screen when the compression format is selected through the format set menu.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of exemplary embodiments, taken in conjunction with the accompanying drawing figures of which:

FIG. 1 is a block diagram of a DVD reproducing device applying a method for storing audio data according to an exemplary embodiment of the present invention;

FIG. 2 is a flowchart of the method for storing the audio data according to an exemplary embodiment of the present invention; and

FIGS. 3A and 3B are views of a menu screen displayed on a screen in a GUI form.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the drawings.

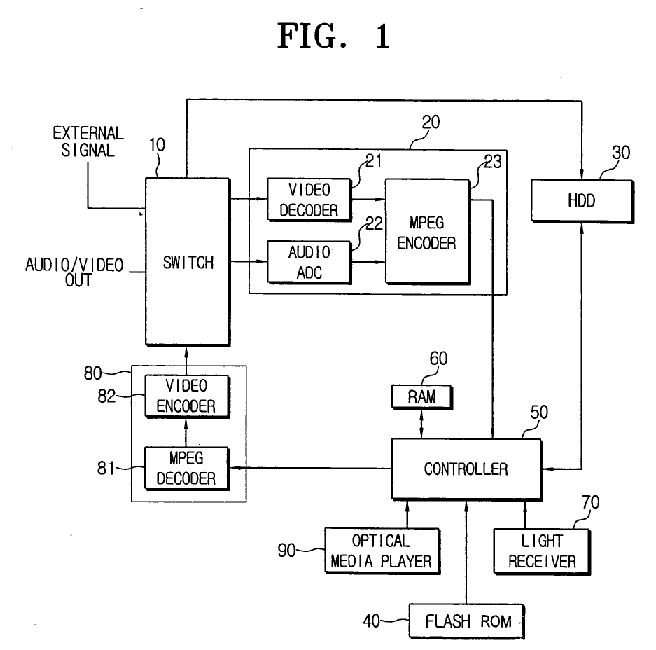

FIG. 1 is a block diagram of a DVD (digital versatile disk) player, which is an AV (audio and video) device applying a method for storing audio data, according to an exemplary embodiment of the present invention.

The DVD player includes a switch 10, a MPEG encoder 20, a hard disk drive (HDD) 30, a flash ROM 40, a controller 50, a RAM 60, a light receiver 70, a decoder 80, and an optical media player 90.

The switch 10 receives various video and aural signal sources from outside or, outputs video signal sources received from the decoder 80 to the outside (for example, onto a monitor screen). The switch 10 receives a broadcast signal and an external signal such as a component and composite signals applied from a video recording and reproducing device (not shown) and selectively connects the received signals to functional blocks of the video recording and reproducing device. For example, if the external signals from an external device such as a video recording and reproducing device are the component or composite signals, the switch 10 applies the signals to the MPEG encoder 20.

The MPEG encoder 20 converts an analog signal among the video signal source received from the switch 10 to a digital signal, and compresses the converted digital signal according to an MPEG format (for example, MPEG-2 format). Generally, the video signal of the MPEG format is compressed so as to reduce storage space on a storage medium such as the HDD 30.

The HDD 30 stores the video and audio signals of the MPEG format as a file. It is feasible to store the video and audio signals of the MPEG format among the video signal source received from the switch 10 as original. This embodiment exemplifies that the HDD 30 stores the video signal of the MPEG-2 format as the file, but not for limitation. The HDD 30 may store the video and/or audio signals as MEPG-1, MPEG-2 and MPEG-4 formats. The MPEG encoder 20 and the decoder 80 encode and decode according to the MPEG-2 format in this embodiment, but are not limited to this format. It is possible to encode and decode according to MPEG-1, MPEG-2 and MPEG4 formats.

The flash ROM 40 contains an operating system for the DVD displayer and application programs. If a music CD of a CD-DA (compact disk digital audio) format is inserted into the optical media player 90, the flash ROM 40 contains a conversion program for converting files of the inserted CD into a certain format (such as, MP3, ogg, or MC) and an application program for displaying a menu on a screen to set conversion options when converting the audio data.

The controller 50 stores the MPEG data output from the MPEG encoder 20 on the HDD 30, or, applies the video and audio signals stored on the HDD 30 to the decoder 80. When a medium (such as a music CD) of the CD-DA format is inserted into the optical media player 90, the controller 50 converts the audio data of the CD-DA format according to the conversion program contained in the flash ROM 40 and stores the converted data on the HDD 30. The controller 50 compresses the audio data of the CD-DA format according to MPEG compression such as MP3, ogg, MC, WMA, ASF, and MP3pro. The controller 50 raises or lowers a compression ratio of the audio data of the CD-DA format by adjusting a sampling rate depending on each format.

The RAM 60 loads the files stored on the HDD 30 through the controller 50 and loads the audio data of the CD-DA format from the optical media player 90. The audio data of the CD-DA format loaded onto the RAM 60 is converted to the MPEG format according to a certain format and sampling rate by the controller 50, and stored on the HDD 30.

The light receiver 70 receives a control signal (not shown) generated in a remote controller (not shown) for controlling the video recording and reproducing device (such as, channel changes, volume control, and image quality adjustment) or a control signal generated in setup keys (not shown) disposed on the video recording and reproducing device, and applies the received signal to the controller 50.

The decoder 80 receives the video signal of the MPEG format stored on the HDD 30 via the controller 50, and converts the video signal to a video format (for example, NTSC or PAL). The converted video signal is reproducible on a video display such as a television. The optical media player 90 reads video and audio signals or audio data of the CD-DA format from a DVD medium, and transfers the read video and audio signals and the audio data to the controller 50. Typically, the optical media player 90 reproducing a DTD title is capable of recognizing the music CD of the CD-DA format.

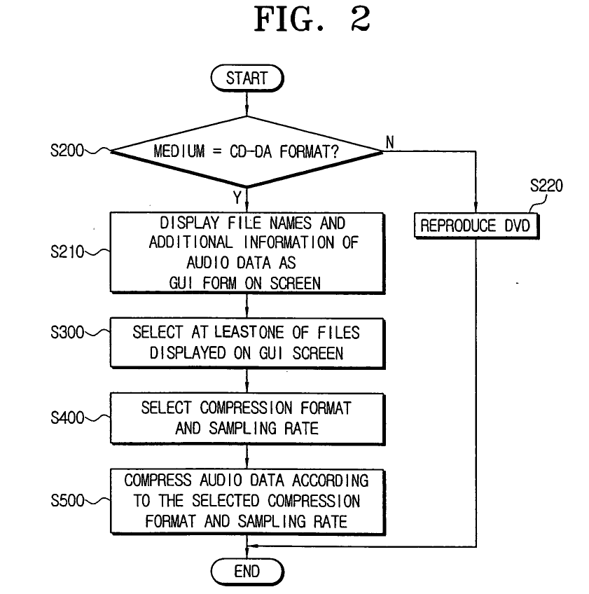

FIG. 2 is a flowchart of a method for storing the audio data according to an exemplary embodiment of the present invention.

The optical media player 90 determines whether the inserted medium is the music CD of the CD-DA format at operation S200. If so, file names of the audio data stored according to the CD-DA format, and additional information (such as a file size and a reproducing time) thereon are displayed on the menu screen of GUI form at operation S210. When the DVD medium is inserted into the optical media player 90, the DVD medium is reproduced and displayed on the screen at operation S220. The file names and the additional information of the audio data are displayed on the screen as the GUI form by the controller 50. the controller 50 operates according to the application program stored in the flash ROM 40.

The file names of the audio data are selected on the menu screen displayed as the GUI form at operation S300. More than one file name can be selected on the menu screen. The file names are selected using the remote controller or the setup keys (not shown) disposed on the DVD player.

The compression format and the sampling rate are set with respect to the audio data corresponding to the selected file name on the menu screen of the GUI form at operation S400. The compression format of the audio data according to the MPEG includes MP3 which is the most prevalent format, WMA (Windows media audio codec) supportable by a media player program of Microsoft Co., Dolby's MC (advanced audio coding) supporting MPEG-2 and MPEG-4, MP3pro capable of adjusting the sampling rate of MP3, and ASF (advanced streaming format) advantageous to the streaming of audio and video in network environment. These compression formats compress audio data based on MPEG-2 or MPEG4, and reduce the audio data to 1/10 as compared with the CD-DA format. One of the above formats is selected on the menu screen displayed in the GUI form, and the sampling rate of the selected audio data is set. The sample rate of the audio data generally ranges from 32 Kbps-192 Kbps.

The audio data is compressed according to the selected compression format and sampling rate at operation S500, and stored on the HDD 30. Accordingly, the HDD 30 can store more audio data than the regular audio data of the CD-DA original format.

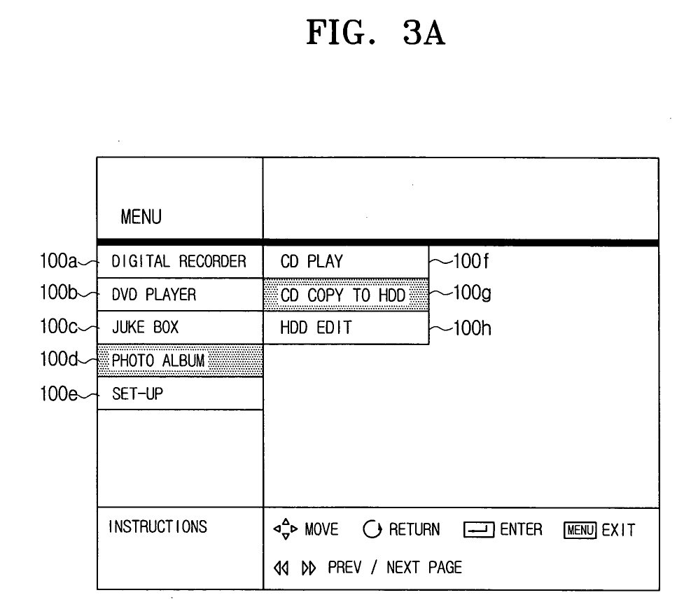

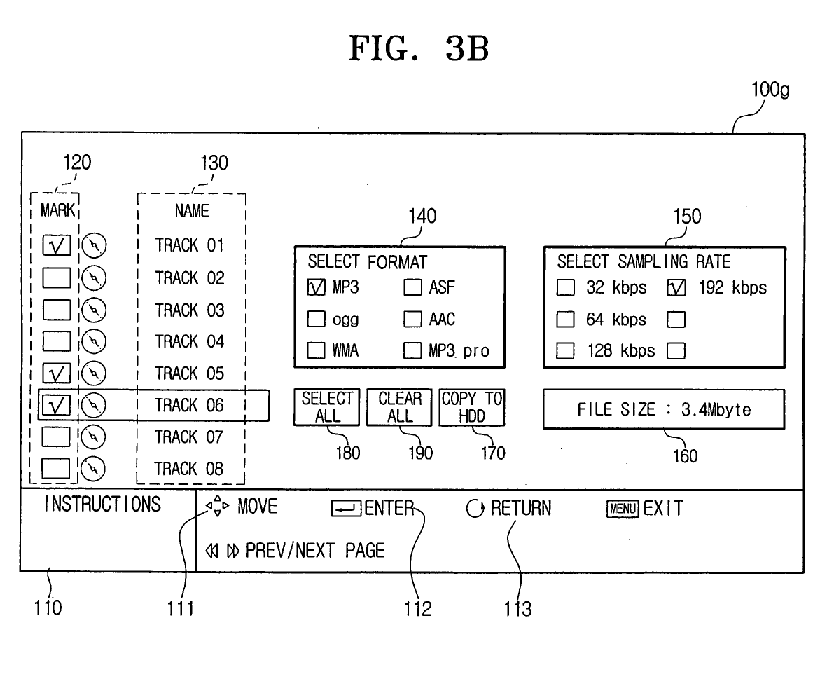

FIGS. 3A and 3B illustrate the menu screen displayed as the GUI form.

FIG. 3A is a main menu displayed when menu keys (not shown) disposed on the remote controller (not shown) are pressed.

The main menu 100 includes a digital recorder menu 110a managing the data stored on the HDD 30, a DVD player menu 110b reproducing the DVD title inserted into the optical media player 90, a juke box menu 100c reproducing or storing on the HDD 30 the music CD of the CD-DA format, which is inserted into the optical media player 90, a photo album menu 100d, and a set-up menu 100e.

To reproduce and copy the music CD of the CD-DA format onto the HDD 30, the juke box menu 100c is selected on the main menu 100 and a CD copy to HDD menu is selected from displayed submenus.

FIG. 3B illustrates submenus of the GUI form displayed when the CD copy to HDD menu is selected.

A menu screen 100g of FIG. 3B is used to compress the audio data of the CD-DA format by pressing menu setup keys (not shown) disposed on the remote controller (not shown). The menu screen 100g includes a menu guide indicator 110, a check box menu 120, a file name indicator 130, a format set menu 140, a sampling rate set menu 150, a file size indicator 160, a file storage menu 170, a select all menu 180, and a clear all menu 190.

The menu guide indicator 110 presents control keys for controlling the menu screen 100g, which are disposed on the remote controller and include a direction key 111, an enter key 112, and a return key 113.

The check box menu 120 is disposed on the left of the file name indicator 130, but can be located at any other position, and is marked when a file is selected by pressing the direction key 111 of the remote controller and the enter key 112 is pressed at the selected file.

The file name indictor 130 presents file names stored on the music CD of the CD-DA format. The file names stored as the CD-DA format are generally presented as Track 01 to Track 08.

The format set menu 140 is used to select one of the convertible formats according to the conversion program stored in the flash ROM 40, and includes check boxes on the left of the formats such as MP3, ogg, ACC, WMA, ASF, and MP3pro, respectively. The format set menu 140, like the check box menu 120, is selected by pressing the direction key 111 of the remote controller and the enter key 112 at the selected file name. When the compression format is selected on the format set menu 140, the sampling rate set menu 150 is popped up on the screen. That is, when a certain format is selected on the format set menu 140, the sampling rate set menu 150 is displayed on the screen without having to separately call a submenu for setting the sampling rate.

The sampling range set menu 150 is used to select the sampling rate for the format selected on the format set menu 140. As the sampling rate decreases, the compression ratio increases but tone quality deteriorates. Conversely, as the sampling rate increases, the tone quality enhances but the compression ratio decreases.

The file size indicator 160 presents a result of compressing the audio data of the CD-DA format read by the optical media player 90 according the format and sampling rate selected on the format set menu 140 and the sampling rate set menu 150, that is, presents the capacity of the compressed audio data.

The file storage menu 170 is used to store on the HDD 30 the compressed audio data according to the sampling rate based on the selected format.

The clear all menu 190 clears all files selected on the check box menu 120. The select all menu 180 compresses all the audio data indicated on the check box menu 120, that is, all the audio data stored in the optical media player 90. As aforementioned, when the audio data of the CD-DA format is applied to the optical media player 90, the audio data is compressed according to the certain format and sampling rate, and the audio data is stored on the HDD 30. Thus, it is possible to store more audio data of the CD-DA format. When the file format is set on the menu screen 100g, the sampling rate set menu 150 is popped up and displayed. Thus, there is no need to select individual submenus using the remote controller. When the certain format is selected on the format set menu 140 of the GUI form, the sampling rate set menu 150 is automatically popped up to be displayed. Thus, there is no need to press the individual keys of the remote controller to display the sampling rate set menu 150.

In light of the foregoing, the audio data of the CD-DA format is converted according to MPEG format and the sampling rate, and the converted audio data is stored in the AV device having the storage medium such as the HDD or the flash ROM. Therefore, storage time of the storage medium of the AV device increases, and the menu set is remarkably facilitated as the sampling rate set menu is popped up upon selecting the compression format.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of storing audio data in an audio and video (AV) device having a display displaying a menu screen, an optical media player reading the audio data, and a storage medium storing the read audio data, the method comprising:
displaying on the menu screen file names and additional information corresponding to the audio data read from the optical media player;
selecting at least one of the file names displayed; and
setting a compression format to compress the audio data corresponding to the selected at least one file name, compressing the audio data according to the set compression format, and storing the compressed data in the storage medium.

2. The method of claim 1, further comprising changing and storing a sampling rate of the audio data corresponding to the selected at least one file name in the storage medium.

3. The method of claim 1, wherein the menu screen comprises:
a menu indicating the file names of the audio data;
a check box menu disposed on a side of the menu in correspondence with the file names; and
a copy menu for copying in the storage medium the audio data corresponding to the at least one file name selected through the check box menu.

4. The method of claim 3, further comprising a format set menu setting the compression format of a file corresponding to the at least one file name selected through the check box menu.

5. The method of claim 4, further comprising a sampling rate set menu setting a sampling rate of the file corresponding to the at least one file name selected through the check box menu.

6. The method of claim 5, wherein the sampling rate set menu is displayed on a screen when the compression format is selected through the format set menu.

7. A method for storing audio data in a storage medium, the method comprising:
determining whether a recorded medium includes audio data;
displaying on a menu screen file names and additional information corresponding to the audio data;
selecting at least one of the file names displayed on the menu screen; and
setting a compression format and a sampling rate of the selected file name, compressing the selected at least one file name according to the set compression format, and storing the compressed at least one file name in the storage medium.

8. The method of claim 7, further comprising a format set menu for setting the compression format of a file corresponding to the selected at least one file name displayed on the menu screen.

9. The method of claim 8, further comprising a sampling rate set menu for setting the sampling rate of the file corresponding to the selected at least one file name.

10. The method of claim 9, wherein the sampling rate set menu is displayed on the menu screen when the compression format is selected through the format set menu.

11. The method of claim 7, wherein the additional information corresponding to the audio data includes a file size and a reproducing time of the file names.

12. The method of claim 7, wherein the menu screen includes a graphic user interface (GUI).

13. The method of claim 12, wherein the GUI comprises:
a menu indicating the file names of the audio data;
a check box menu for selecting the file names and located on a side of the menu in correspondence with the file names; and
a copy menu for copying to the storage medium the audio data corresponding to the file names selected through the check box menu.

14. A method for storing audio data in a storage medium, the method comprising:
displaying on a menu screen file names and information corresponding to audio data;
selecting a file name displayed on the menu screen; and
setting a compression format and a sampling rate of the selected file name, compressing the selected file name according to the set compression format, and storing the compressed file name in the storage medium.

15. The method of claim 14, further comprising a format set menu for setting the compression format of a file corresponding to the selected file name displayed on the menu screen.

16. The method of claim 15, further comprising a sampling rate set menu for setting the sampling rate of the file corresponding to the selected file name.

17. The method of claim 16, wherein the sampling rate set menu is displayed on the menu screen when the compression format is selected through the format set menu.
